(19) United States
(12) Patent Application Publication
(10) Pub. No.: US 2025/0356646 A1
(43) Pub. Date: Nov. 20, 2025

(54) IMAGE CLASSIFICATION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventor: Cheng ZHU, Shenzhen (CN)

(21) Appl. No.: 19/281,746

(22) Filed: Jul. 27, 2025

Related U.S. Application Data
(63) Continuation of application No. PCT/CN2023/132546, filed on Nov. 20, 2023.

(30) Foreign Application Priority Data
Jun. 21, 2023 (CN) 202310746237.3

(51) Int. Cl. G06V 10/82; G06V 10/75; G06V 10/771; G06V 10/774

(52) U.S. Cl. CPC G06V 10/82; G06V 10/751; G06V 10/771; G06V 10/774

(57) ABSTRACT

An image classification method includes: obtaining an original image and prompt texts, each prompt text being generated according to an image label that corresponds to a preset image category; for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image; selecting, according to differences calculated for predicted noise images, a predicted noise image having a smallest difference, and acquiring a prompt text based on which the selected predicted noise image is generated; and using an image label corresponding to the acquired prompt text as an image label of the original image.

### CROSS-REFERENCES TO RELATED APPLICATIONS

This application is a continuation application of PCT Patent Application No. PCT/CN2023/132546, filed on Nov. 20, 2023, which claims priority to Chinese Patent Application No. 202310746237.3, filed on Jun. 21, 2023, all of which is incorporated herein by reference in their entirety.

### FIELD OF THE TECHNOLOGY

The present disclosure relates to the field of computer technologies, and in particular, to an image classification method and apparatus, a computer device, a storage medium, and a program product.

### BACKGROUND OF THE DISCLOSURE

With the rapid development of artificial intelligence and computer technologies, image processing technologies have been applied to various business scenarios. In an image classification technology, an image is quantitatively analyzed by using image features, and the entire image or each pixel or area in the image is classified into one of several categories (or labels), thereby replacing manual visual interpretation.

Image classification has a wide range of application scenarios. For example, image classification can be applied to image recognition, to identify animals, plants, vehicle models, fruits, vegetables, or the like. For another example, photos captured with a smartphone can be automatically classified through image classification. For another example, image classification can be applied in e-commerce platforms for image content retrieval. The e-commerce backend can classify product images and build a database, so that when a user performs image search, a more accurate result can be provided. In addition, image classification may also be applied to scenarios such as garbage sorting.

Currently, the accuracy of image classification in a specific business domain often relies on a large amount of manually annotated image data within the business domain, and a significant improvement of the classification performance requires an increase in the volume of manually annotated image data. However, the quality of the manually annotated image data can vary, and the manual annotation requires huge workload, with high costs and low efficiency, making it difficult to promptly launch an image classification in specific business areas.

### SUMMARY

One embodiment of the present disclosure provides an image classification method, performed by a computer device. The method includes: obtaining an original image and a plurality of prompt texts, each prompt text being generated according to an image label, and each image label corresponding to a preset image category; for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image; selecting, according to differences calculated for predicted noise images, a predicted noise image having a smallest difference, and acquiring a prompt text based on which the selected predicted noise image is generated; and using an image label corresponding to the acquired prompt text as an image label of the original image.

Another embodiment of the present disclosure provides a computer device. The computer device includes one or more processors and a memory containing computer-readable instructions that, when being executed, cause the one or more processors to perform: obtaining an original image and a plurality of prompt texts, each prompt text being generated according to an image label, and each image label corresponding to a preset image category; for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image; selecting, according to differences calculated for predicted noise images, a predicted noise image having a smallest difference, and acquiring a prompt text based on which the selected predicted noise image is generated; and using an image label corresponding to the acquired prompt text as an image label of the original image

Another embodiment of the present disclosure provides a non-transitory computer-readable storage medium containing computer-readable instructions that, when being executed, cause at least one processor to perform: obtaining an original image and a plurality of prompt texts, each prompt text being generated according to an image label, and each image label corresponding to a preset image category; for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image; selecting, according to differences calculated for predicted noise images, a predicted noise image having a smallest difference, and acquiring a prompt text based on which the selected predicted noise image is generated; and using an image label corresponding to the acquired prompt text as an image label of the original image.

Details of one or more embodiments of the present disclosure are provided in the accompany drawings and descriptions below. Other features, objectives, and advantages of the present disclosure become clear from the specification, the accompanying drawings, and the claims.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following descriptions show merely some embodiments of the present disclosure, and a person of ordinary skill in the art may still derive other drawings from these disclosed accompanying drawings without creative efforts.

FIG. 1 is a diagram of an application environment of an image classification method according to an embodiment of the present disclosure.

FIG. 2 is a schematic flowchart of an image classification method according to an embodiment of the present disclosure.

FIG. 3 is a schematic structural diagram of a diffusion model.

FIG. 4 is a schematic diagram of a whole frame of an image classification method.

FIG. 5 is a schematic structural diagram of a noise predictor according to an embodiment of the present disclosure.

FIG. 6 is a schematic diagram of a training process of a CLIP model according to an embodiment of the present disclosure.

FIG. 7 is a schematic diagram of a data set configured for training in a diffusion model according to an embodiment of the present disclosure.

FIG. 8 is a schematic diagram of a training process of a first training stage of an initial diffusion according to an embodiment of the present disclosure.

FIG. 9 is a schematic diagram of a training process of a second training stage of an initial diffusion image.

FIG. 10 is a structural block diagram of an image classification apparatus according to an embodiment of the present disclosure.

FIG. 11 is a structural block diagram of a diffusion model processing apparatus according to an embodiment of the present disclosure.

FIG. 12 is a diagram of an internal structure of a server according to an embodiment of the present disclosure.

### DESCRIPTION OF EMBODIMENTS

To make the objectives, the technical solutions, and the advantages of the present disclosure clearer, the following further describes the present disclosure in detail with reference to the accompanying drawings and the embodiments. The specific embodiments described herein are merely used for explaining the present disclosure, and are not used for limiting the present disclosure.

A diffusion model is a condition model that relies on a prior. In an image generation task, a prior is usually a text, an image, or a semantic graph. In other words, the diffusion model generates a corresponding image according to an input text, image, or semantic graph.

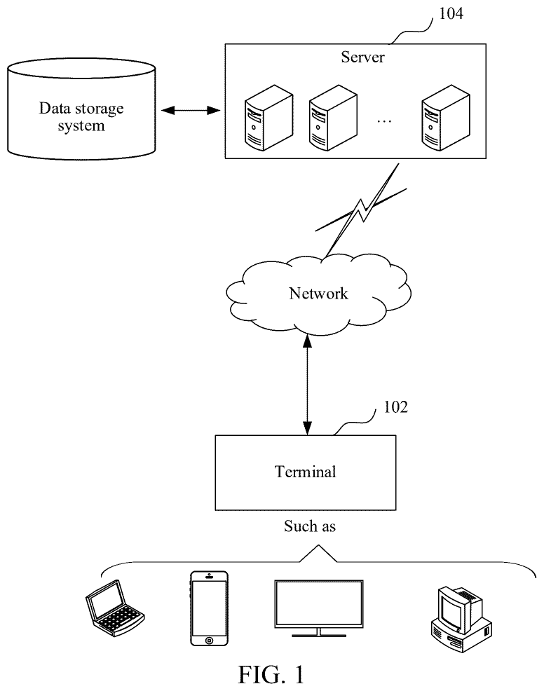

An image classification method provided in the embodiments of the present disclosure may be applied to an application environment shown in FIG. 1. A server 104 obtains an original image and a plurality of prompt texts from a terminal 102. Each prompt text is generated according to an image label, and each image label corresponds to a preset image category (e.g., a present image classification category). In one embodiment, each image label is the preset image category or present image classification category. For each prompt text, the server 104 inputs the original image, the prompt text, and a random noise image into a trained diffusion model to generate a noisy image according to the original image and the random noise image, generates a predicted noise image according to the noisy image and the prompt text, and calculates a difference between the generated predicted noise image and the random noise image. The server 104 selects, according to the differences calculated for the predicted noise images, the predicted noise image having a smallest difference, and acquires the prompt text based on which the selected predicted noise image is generated. The server 104 uses the image label corresponding to the acquired prompt text as an image label of the original image. A data storage system may store the plurality of prompt texts that the server 104 needs to process. The data storage system may be integrated on the server 104, or may be placed on a cloud or another server.

In another embodiment, the image classification method may alternatively be performed by the terminal 102. The terminal 102 obtains an original image and a plurality of prompt texts, for each prompt text, inputs the original image, the prompt text, and a random noise image into a trained diffusion model, and determines an image label of the original image.

The terminal 102 may be, but is not limited to, any desktop computer, notebook computer, smartphone, tablet computer, Internet of Things device, and portable wearable device. The Internet of Things device may be a smart in-vehicle device, or the like. The portable wearable device may be a smart watch, a smart band, a head-mounted device, and the like. The server 104 may be implemented by using an independent server or a server cluster that includes a plurality of servers.

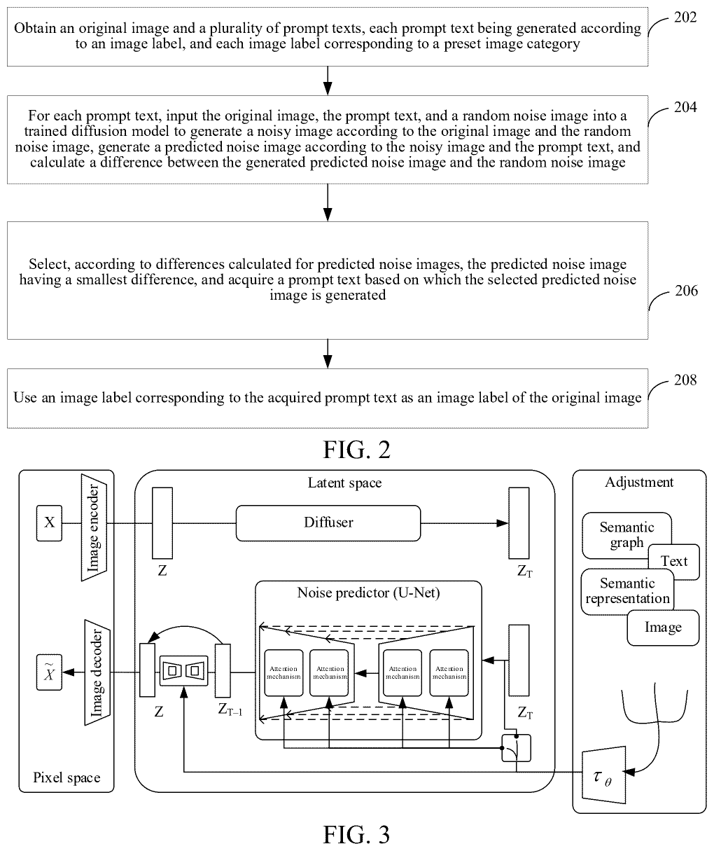

In an embodiment, as shown in FIG. 2, an image classification method is provided. A description is made by using an example in which the method is applied to the server in FIG. 1. The method includes the following operations.

Operation 202: Obtain an original image and a plurality of prompt texts, each prompt text being generated according to an image label, and each image label being a preset image category.

The prompt text is prior content of generating an image by a diffusion model. In other words, the diffusion model generates an image based on the prompt text. The prompt text includes an image label. The image label corresponds to a preset image category. For example, the image label may be scenery, food, a building, an animal, or a person. Multi-label image classification is a process of classifying an image as one or more of a plurality of image labels. In this embodiment, different weights are set for image labels, or image labels are mixed, to generate prompt texts according to different image labels. Each prompt text is different. A format of the prompt text is usually A photo of a {class}, where class is an image label. For example, the prompt text is {A photo of a T-shirt}.

In some embodiments, the original image may be a commodity image, and the image label may be a commodity category. For example, the commodity category may be a household product, a mother and baby product, a costume product, a makeup product, or the like. Multi-label image classification is performing commodity classification on a commodity image.

In some embodiments, the original image may be a video cover, and the image label may be a video category. For example, the video category may be a comedy category, an action category, a horror category, a science fiction category, or the like. Multi-label image classification is performing video classification on video covers.

The server may obtain image labels under a preset image classification label system, obtain a preset prompt text template, sequentially traverse image labels under the preset image classification label system, and fill the prompt text template with traversed image labels, to obtain a prompt text corresponding to each image label. It can be seen that the prompt text is a sentence of image description text, also referred to as a prompt. The preset image classification label system is a set of image labels of service images that can be involved in a specific application scenario. In one embodiment, the term “service image” may refer to business image, business-specific image, or the like, depending on the specific application scenarios.

Operation 204: For each prompt text, input the original image, the prompt text, and a random noise image into a trained diffusion model to generate a noisy image according to the original image and the random noise image, generate a predicted noise image according to the noisy image and the prompt text, and calculate a difference between the generated predicted noise image and the random noise image.

Noise is usually represented on an image as isolated pixel points or pixel blocks that cause a strong visual effect. These pixel points or pixel blocks are factors that prevent people from accepting information. Commonly speaking, the noise makes an image unclear. Therefore, an image generated according to the noise may be referred to as a noise image. The random noise image is an image configured for representing Gaussian noise, for example, random noise. The random noise may be randomly determined through Gaussian distribution. The random noise image is denoted as sample ε˜N(0, 1), where N(0, 1) represents Gaussian distribution, and ε represents random noise. Generation of the random noise image is related to a random noise amount. The random noise amount is denoted as t. Different random noise amounts t may be configured for simulating a perturbation process that is gradually stronger with time. Each random noise amount represents a perturbation process. From an initial state, distribution of an image is gradually changed by applying noise for multiple times. Therefore, a small random noise amount represents weak noise perturbation, and a large random noise amount represents stronger noise perturbation.

A computer device invokes a diffusion model and generates an image based on a prompt text by using the diffusion model. FIG. 3 is a schematic structural diagram of a diffusion model. As shown in FIG. 3, the diffusion model includes a Contrastive Language-Image Pre-training (CLIP) model, a diffuser, a noise predictor, and an image decoder. The CLIP model includes an image encoder and a text encoder. A process of the diffusion model generating a predicted image is: an original image X is encoded by the image encoder, to obtain an image encoding representation, denoted as Z, of the original image in a latent space; the image encoding representation Z is inputted into the diffuser, and the image encoding representation Z and the random noise image sample ε˜N (0,1) are superimposed by using the diffuser, to generate a noisy image Z_{T}; semantic encoding is performed on the prompt text by using the text encoder, to obtain a textual semantic representation corresponding to the prompt text, which is denoted as τ_{θ}; the noisy image Z_{T}, the textual semantic representation τ_{θ}, and encoding information of the random noise amount are inputted into the noise predictor, and a predicted noise image is generated by using the noise predictor; the predicted noise image is subtracted from the noisy image Zr according to a preset formula, to obtain a predicted noisy image corresponding to a previous operation of the random noise amount t, which is denoted as Z_{T-1}; the predicted noisy image Z_{T-1}, the textual semantic representation τ_{θ}, and encoding information of a random noise amount t-1 are inputted into the noise predictor, and a predicted noisy image Z_{T-2} is generated by using the noise predictor; and the rest can be deduced by analogy until the noise predictor generates a predicted noisy image Z₀, that is, a corresponding image encoding representation Z when no random noise is superimposed is obtained. The predicted noisy image Z₀ is decoded by using the image decoder, to obtain a predicted image \tilde{X}.

In this embodiment, a processing manner for each prompt text is the same. To be specific, an original image, one prompt text, and a random noise image are inputted into a trained diffusion model, after the diffusion model outputs a predicted noise image, the original image, a next prompt text, and a random noise image are inputted into the trained diffusion model, until the original image, the last prompt text, and a random noise image are inputted into the trained diffusion model. When each prompt text is inputted into the diffusion model in sequence, in each process of the diffusion model generating a predicted noise image based on the prompt text, a random noise image used may be the same or may be different.

Specifically, a server reads a prompt text from a plurality of prompt texts, inputs an original image, a prompt text, and a random noise image into a trained diffusion model, and encodes the original image by using an image encoder, to obtain an image encoding representation of the original image in a latent space; inputs the image encoding representation and the random noise image to a diffuser, and superimposes the image encoding representation and the random noise image by using the diffuser, to generate a noisy image; performs semantic encoding on the prompt text by using a text encoder, to obtain a textual semantic representation corresponding to the prompt text; and inputs the noisy image, the textual semantic representation, and encoding information of a random noise amount into a noise predictor, generates a predicted noise image by using the noise predictor, and calculates a difference between the generated predicted noise image and the random noise image.

The server extracts again, from the plurality of prompt texts, a prompt text not inputted into the diffusion model, repeats the operation of inputting the original image, the prompt text, and the random noise image into the trained diffusion model, and continues to perform the step, until the plurality of prompt texts are all inputted into the diffusion model, to obtain a difference between a predicted noise image corresponding to each prompt text and a random noise image, where the difference is a difference between noise of the predicted noise image and the random noise image.

Operation 206: Select, according to the differences calculated for the predicted noise images, the predicted noise image having a smallest difference, and acquire the prompt text based on which the selected predicted noise image is generated.

The predicted noise image having the smallest difference is a corresponding predicted noise image having the smallest difference from the random noise image. The prompt text on which the predicted noise image having the smallest difference is based is a prompt text required for generating the predicted noise image. For example, there are M prompt texts, M predicted noise images are generated corresponding to the M prompt texts, a prompt text on which a predicted noise image having the smallest difference from the random noise image in the M predicted noise images is based is Mi, Mi represents an i^{th} prompt text, and an image label corresponding to the prompt text Mi is determined as the image label of the original image.

In some embodiments, a plurality of prompt texts based on which a predicted noise image having a small difference is generated may further be determined, and the image labels corresponding to the determined prompt texts are determined as image labels of the original image. That is, the original image corresponds to a plurality of image labels.

The small difference refers to arranging a difference between each predicted noise image and the random noise image in ascending order, selecting prompt texts on which predicted noise images having a small difference rely in ascending order of differences are based, and using the image labels corresponding to the selected prompt texts as the image labels of the original image.

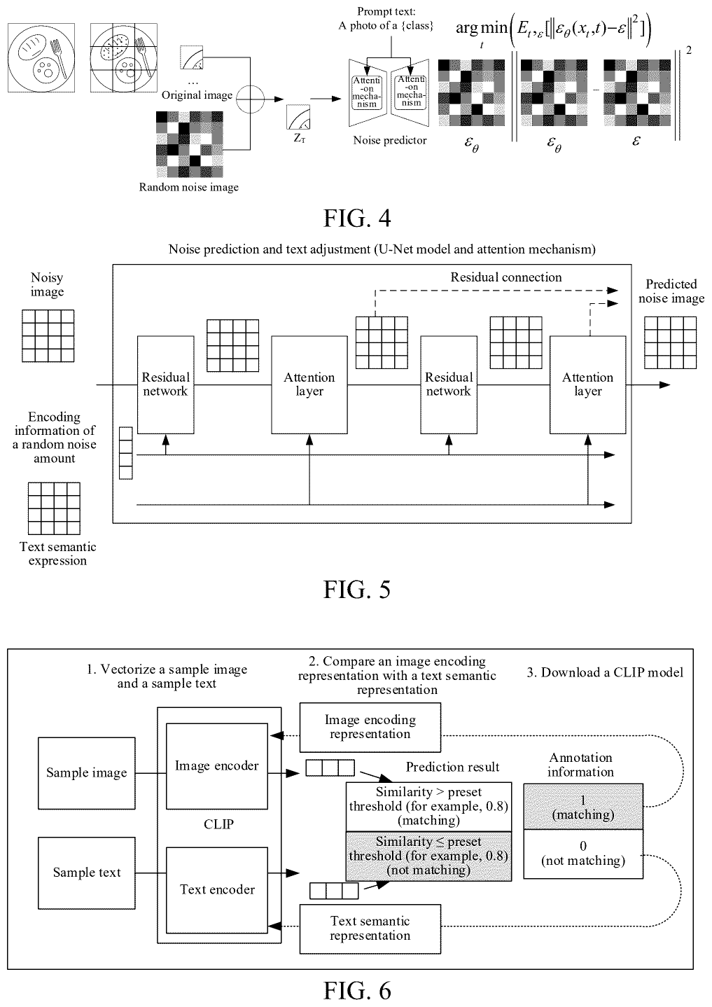

In some embodiments, FIG. 4 is a schematic diagram of a whole frame of an image classification method. Referring to FIG. 4, after operation 204, a calculation formula shown below may be used to obtain a difference between a predicted noise image corresponding to each prompt text and the random noise image, and a prompt text on which a predicted noise image having the smallest difference is based is selected. A corresponding calculation formula is as follows:

$${arg min}_{t} ( {E}_{t} {,}_{ε} [ {‖ {ε}_{θ} ( {x}_{t} , t ) - ε ‖}^{2} ] )$$

ε represents a random noise image; ε_{θ} represents a predicted noise image; xₜ represents a noisy image; Eₜ represents a predicted image; and t represents a random noise amount.

Specifically, the server calculates a difference between the predicted noise image ε_{θ} and the random noise image ε, and determines a prompt text on which a predicted noise image having the smallest difference from the random noise image ε in the predicted noise image ε_{θ}.

Operation 208: Determine the image label corresponding to the obtained prompt text as an image label of the original image.

Specifically, after determining the prompt text based on which the predicted noise image having the smallest difference is generated, the server determines the image label corresponding to the determined prompt text as the image label of the original image.

In the foregoing image classification method, a plurality of prompt texts are obtained, where each prompt text is generated according to a different image label. For each prompt text, an original image, a prompt text, and a random noise image are inputted into a trained diffusion model. A predicted noise image is generated by using the diffusion model. A difference between the generated predicted noise image and the random noise image is calculated. That is, each prompt text corresponds to a random noise image. An image label corresponding to a prompt text based on which a predicted noise image having the smallest corresponding difference is generated is determined as an image label of the original image. According to the foregoing method, a capability of a diffusion model may be directly migrated to a multi-label classification task, and a service image (including for example, an original image) in a specific application scenario is classified by directly using the diffusion model. In this way, classification is performed without training an image classification model by relying manually annotating image data and using the trained image. Because training needs a large amount of manually annotated image data, this can reduce a workload of manual annotation, greatly reduce a cost of the manual annotation, and can further improve efficiency of multi-label classification of images.

In an embodiment, the inputting the original image, the prompt text, and a random noise image into a trained diffusion model to generate a noisy image according to the original image and the random noise image includes the following operations:

performing image encoding on the original image by using an image encoder of the diffusion model, to obtain an image encoding representation of the original image; and superimposing noise information corresponding to the random noise image onto image encoding information by using a diffuser of the diffusion model, to obtain the noisy image.

The image encoder is an image encoder in a CLIP model, and is configured to encode an original image, so that the original image can be represented in the latent space, and an obtained image encoding representation is an image embedding vector. The latent space is a common term in the field of generation, represents high-dimensional information of an image, and is usually configured for feature alignment of a generation result.

Noise information corresponding to the random noise image is superimposed onto the image encoding information to destroy the original image, to obtain the noisy image, and a predicted image is generated again in a denoising process of the noisy image.

Specifically, the server performs image encoding on the original image by using the image encoder in the CLIP model, to obtain the image encoding representation of the original image, where the image encoding representation of the original image is an image representation of the original image in the latent space; and the server superimposes, by using the diffuser of the diffusion model, the noise information corresponding to the random noise image onto the image encoding information, to obtain the noisy image.

In this embodiment, image encoding is performed on the original image by using the image encoder in the CLIP model, so that the original image can be represented in the latent space, and superimposition of the noise information corresponding to the random noise image onto the image encoding information is also performed in the latent space. Through diffusion in the latent space, high generation quality can be maintained and computing resource consumption can be reduced.

In an embodiment, the generating a predicted noise image according to the noisy image and the prompt text includes the following operations:

performing semantic encoding on the prompt text by using a text encoder of the diffusion model, to obtain a textual semantic representation corresponding to the prompt text; and inputting the noisy image and the textual semantic representation into a noise predictor of the diffusion model, and outputting a predicted noise image by using the noise predictor.

The text encoder of the diffusion model is a text encoder of the CLIP model. Semantic encoding is performed on the prompt text by using the text encoder, so that the prompt text can be represented in the latent space. The textual semantic representation is usually a text embedding vector.

Specifically, the server performs semantic encoding on the prompt text by using the text encoder of the CLIP model in the diffuser, to obtain the textual semantic representation corresponding to the prompt text; and inputs the noisy image, the textual semantic representation, and encoding information of a random noise amount into the noise predictor of the diffusion model, and outputs the predicted noise image by using the noise predictor, where the encoding information of the random noise amount is a vector representation obtained by encoding the random noise amount.

In an embodiment, the noise predictor includes a plurality of residual networks and attention layers that are alternately connected; and the inputting the noisy image and the textual semantic representation into a noise predictor of the diffusion model, and outputting a predicted noise image by using the noise predictor includes the following operations.

1. Input the noisy image and encoding information of a random noise amount corresponding to the random noise image into a first residual network, and output predicted noise information by using the first residual network; and input the predicted noise information and the textual semantic representation into a first attention layer, and output attention information by using the first attention layer.

In some embodiments, a U-Net model may be used for the noise predictor. To add a textual semantic representation to a noise prediction process, a schematic structural diagram of a noise predictor in this embodiment is shown in FIG. 5. Referring to FIG. 5, for a prompt text, a text encoder of a CLIP model is used to compress the prompt text into a textual semantic expression. The textual semantic expression may be a text embedding vector. In a denoising process of the U-Net model, a text embedding vector is continuously injected to the denoising process by using an attention mechanism, and each residual network is no longer directly connected to an adjacent residual network, but an attention layer is newly added between the adjacent residual networks. In the CLIP model, a text embedding vector obtained by the text encoder is processed by using the attention layer. In this manner, the textual semantic expression can be continuously injected.

The encoding information of the random noise amount is a vector representation obtained by encoding the random noise amount. The predicted noise information and the attention information respectively represent multi-dimensional arrays in different dimensions, and are sequentially processed by a plurality of residual networks and attention layers that are alternately connected in the U-Net model, to obtain a predicted noise image.

Specifically, the server encodes the random noise amount of the random noise image by using an encoder, to obtain encoding information of the random noise amount, inputs the noisy image and the encoding information of the random noise amount into the first residual network, and outputs the predicted noise information by using the first residual network; and inputs the predicted noise information and the textual semantic representation into the first attention layer, and outputs the attention information by using the first attention layer.

2. Starting from the second residual network, sequentially use a next residual network as a current residual network, use a next attention layer as a current attention layer, input a previous piece of attention information outputted by a previous attention layer connected to the current residual network and the encoding information of the random noise amount into the current residual network, and output predicted noise information by using the current residual network; and input the predicted noise information outputted by the current residual network and the textual semantic representation into the current attention layer, and output attention information by using the current attention layer.

Specifically, the server sequentially uses, starting from the second residual network, a next residual network as a current residual network, uses the second attention layer as a current attention layer, inputs a previous piece of attention information outputted by a previous attention layer connected to the current residual network and the encoding information of the random noise amount into the current residual network, and outputs predicted noise information by using the current residual network; inputs the predicted noise information outputted by the current residual network and the textual semantic representation into the current attention layer, and outputs attention information by using the current attention layer; and uses a next residual network connected to the current attention layer as a current residual network, and uses a next attention layer as a current attention layer, repeats the operation of inputting a previous piece of attention information outputted by a previous attention layer connected to the current residual network and the encoding information of the random noise amount into the current residual network, and continues to perform the operation until the current residual network is the last residual network and the current attention layer is the last attention layer.

3. Determine attention information outputted by the last attention layer as the predicted noise image.

The attention information outputted by the last attention layer is also output of the noise predictor. Therefore, the attention information outputted by the last attention layer is determined as the predicted noise image.

In this embodiment, in a process of generating a predicted noise image according to a noisy image and a prompt text, a plurality of attention layers are introduced into a noise predictor, and a textual semantic expression is added, by using the attention layer, to predicted noise information outputted by a residual network. In this way, the textual semantic expression can be continuously injected to the noise predictor, so that a predicted noise image outputted by the noise predictor has a higher matching degree with an original image.

In an embodiment, a training process of the CLIP model specifically includes the following operations.

1. Obtain a training sample, the training sample including a sample text, a sample image, and annotation information indicating whether the sample text matches the sample image.

The sample text includes an image label. The image label corresponds to a preset image category, and the sample text is a segment of image description text. A target of training the CLIP model is to enable the model to performing matching between texts and images.

The annotation information includes that the sample text matches the sample image or that the sample text does not match the sample image, and may be represented by using 0 or 1. Certainly, whether the sample text matches the sample image may alternatively be quantified in other forms.

Specifically, the server randomly selects a training sample from a training set. The training sample includes a sample text and a sample image, and further includes annotation information indicating whether the sample text matches the sample image.

2. Perform image encoding on the sample image by using an initial image encoder, to obtain an image encoding representation of the sample image.

The initial image encoder is an image encoder in an initial state in the CLIP model. After the image encoding is performed on the sample image by using the initial image encoder, the obtained image encoding representation is an image embedding vector.

3. Perform semantic encoding on the sample text by using an initial text encoder, to obtain a textual semantic representation corresponding to the sample text.

The initial text encoder is a text encoder in an initial state in the CLIP model. After the semantic encoding is performed on the sample text by using the initial text encoder, the obtained textual semantic representation is a text embedding vector.

4. Calculate a similarity between the image encoding representation and the textual semantic representation, and determine, according to the similarity, a prediction result indicating whether the sample text matches the sample image.

In this embodiment, the similarity between the image encoding representation and the textual semantic representation, that is, a prediction result, may be calculated by using a cosine similarity. A larger prediction result indicates that the model predicts that the sample text and the sample image are more matched, and a smaller prediction result indicates that the model predicts that the sample text and the sample image are less matched.

5. Construct a sample loss according to a difference between the annotation information and the prediction result, and after updating the initial image encoder and the initial text encoder according to the sample loss, repeat the operation of obtaining a training sample to continue training, to obtain the image encoder of the diffusion model and the text encoder of the diffusion model.

When training of the CLIP model starts, even if a sample text matches a sample image, parameters are chaotic because an initial image encoder and an initial text encoder in the CLIP model have just been initialized. Consequently, an image encoding representation and a textual semantic representation are certainly chaotic, and a calculated similarity is usually close to 0. In this case, a situation shown in FIG. 6 may occur. The sample text matches the sample image, but the cosine similarity indicates that the sample text does not match the sample image. In this case, the annotation information and the prediction result are different and have a large difference. Parameters of the initial image encoder and the initial text encoder need to be inversely updated according to a comparison result between the annotation information and the prediction result.

By continuously repeating the foregoing back propagation process, the initial image encoder and the initial text encoder can be trained, to obtain the image encoder of the diffusion model and the text encoder of the diffusion model. If in the annotation information, 1 indicates that the sample text matches the sample image, and 0 indicates that the sample text does not match the sample image, the trained CLIP model needs to have such capabilities: for a sample image and a sample text that are paired, the image encoder of the diffusion model and the text encoder of the diffusion model may finally output similar embedding vectors, and a result close to 1 may be obtained by calculating the cosine similarity, indicating that the sample image and the sample text are matched; and for a sample image and a sample text that are not matched, the image encoder of the diffusion model and the text encoder of the diffusion model output quite different embedding vectors, and a calculated cosine similarity is close to 0, indicating that the sample image and the sample text are unmatched. For example, a picture of a puppy is inputted into the image encoder of the CLIP model, a text description: “puppy photo” is inputted into the text encoder of the CLIP model, and the CLIP model generates two similar embedding vectors, so that it is determined that the sample text matches the sample image. In this case, two types of originally irrelevant information, computer vision and human language, are associated with each other by using the CLIP model, and have a unified mathematical representation. The prompt text may be converted into an image representation by using a text encoder, or the prompt text may be converted into a semantic representation by using an image encoder. The image representation and the semantic representation can interact with each other.

The constructing a sample loss is specifically that the server may calculate a relative distance between the annotation information and the prediction result by using a loss function, and if the relative distance is less than a preset value, update of the parameters of the CLIP model is stopped, to obtain a trained image encoder of the diffusion model and a trained text encoder of the diffusion model.

Specifically, the server constructs the sample loss according to the difference between the annotation information and the prediction result, updates the parameters of the initial image encoder and the initial text encoder, and repeats the operation of obtaining a training sample to continue training, until the sample loss is less than a preset value, and stops training of the CLIP model, to obtain the image encoder of the diffusion model and the text encoder of the diffusion model.

In this embodiment, the CLIP model is trained, so that two types of originally irrelevant information, computer vision and human language, are associated with each other by using the CLIP model, and have a unified mathematical representation. The prompt text may be converted into an image representation by using a text encoder, or the prompt text may be converted into a semantic representation by using an image encoder. The image representation and the semantic representation can interact with each other, and provides a basis for the diffusion model to generate a predicted picture through a prompt text.

In an embodiment, the obtaining a plurality of prompt texts includes the following operations:

obtaining a prompt text template and a plurality of image labels; and filling the prompt text template with each of the plurality of image labels respectively, to obtain a plurality of prompt texts corresponding to the corresponding image labels.

In this embodiment, a plurality of image label sets includes a first image label set and a second image label set. A first image label in the first image label set and a second image label in the second image label set are combined to obtain a plurality of image labels. The first image label in the first image label set and the second image label in the second image label set are from different image application scenarios. For example, the first image label is from an image label of a training sample in original training data of the diffusion model, and the second image label is from an image label of a service image of a service. The service refers to a specific application scenario in different fields.

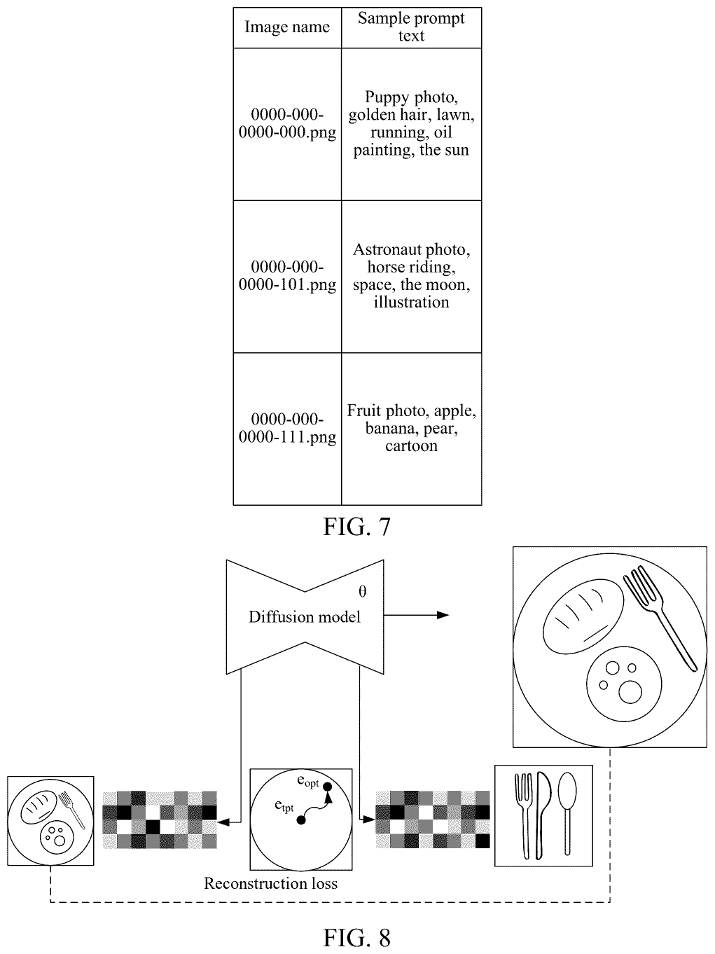

A general format of a prompt text is a photo of {class}, and prompt texts corresponding to M image labels are respectively represented as: A photo of class1, A photo of class2, . . . , and A photo of classM. FIG. 7 shows a format of a data set used for training in the diffusion model. A text shown in a prompt text column in FIG. 7 is denoted as a prompt text.

Specifically, the server reads a plurality of first image labels from a prestored first image label set, reads a plurality of second image labels from a prestored second image label set, and fills the prompt text template with the plurality of first image labels and the plurality of second image labels respectively, to obtain a plurality of prompt texts corresponding to the corresponding image labels.

In this embodiment, image labels from different image application scenarios are mixed, to obtain the plurality of image labels required in this embodiment, so that in the process of generating the predicted image based on the prompt text by the diffusion model, the determined prompt text based on which the predicted noise image having the smallest corresponding difference is generated includes the image label of this service, thereby ensuring that the image label allocated to the original image includes the image label of this service, and improving label annotation precision of the original image.

In an embodiment, because a feature on the original image is within a size range of the original image and occupies a small range, to perform precise image label classification on the feature, in this embodiment, the method further includes:

dividing the original image, to obtain a plurality of subimages.

Specifically, as shown in FIG. 4, the server divides the original image according to an N*N grid. For example, N may be 3, and the original image is divided into 9 subimages.

Correspondingly, operation 204 may include the following operations.

1. Sequentially obtain a prompt text from the plurality of prompt texts, for each obtained prompt text, input the subimage, the obtained prompt text, and the random noise image into the trained diffusion model, generate a noisy subimage according to the subimage and the random noise image by using the diffusion model, generate a predicted noise subimage according to the noisy subimage and the prompt text, and calculate a difference between the generated predicted noise subimage and the random noise image.

A processing manner for each of the plurality of subimages obtained through division is the same. To be specific, one subimage, one prompt text, and the random noise image are inputted into the trained diffusion model. After the diffusion model outputs a predicted noise subimage, the subimage, a next prompt text, and the random noise image are inputted into the trained diffusion model. This cycle is repeated in sequence, until the subimage, the last prompt text, and the random noise image are inputted into the trained diffusion model, to obtain a plurality of predicted noise subimages corresponding to the subimage. A next subimage, one prompt text, and the random noise image are continuously inputted into the trained diffusion model and the operation is continuously performed, until a plurality of predicted noise subimages corresponding to all the subimages are obtained.

For each subimage, a size of the corresponding random noise image needs to be the same as a size of the subimage, and for the original image, a size of the corresponding random noise image needs to be the same as a size of the original image.

Specifically, the server extracts one subimage from the plurality of subimages, reads one prompt text from the plurality of prompt texts, inputs the subimage, the prompt text, and the random noise image into the trained diffusion model, and encodes the subimage by using an image encoder, to obtain an image encoding representation of the subimage in the latent space; inputs the image encoding representation and the random noise image into the diffuser, and superimposes the image encoding representation and the random noise image by using the diffuser, to generate a noisy subimage; performs semantic encoding on the prompt text by using the text encoder, to obtain a textual semantic representation corresponding to the prompt text; and inputs the noisy subimage, the textual semantic representation, and the encoding information of the random noise amount into the noise predictor, generates a predicted noise subimage by using the noise predictor, and calculates a difference between the generated predicted noise subimage and the random noise image. The server extracts again, from the plurality of prompt texts, a prompt text not inputted into the diffusion model, repeats the operation of inputting the subimage, the prompt text, and the random noise image into the trained diffusion model, and continues to perform the step, until the plurality of prompt texts are all inputted into the diffusion model, to obtain a difference between a predicted noise subimage corresponding to each prompt text of the subimage and a random noise image, where the difference is a difference between noise of the predicted noise subimage and the random noise image.

The server extracts again, from the plurality of subimages, a subimage not inputted into the diffusion model, repeats perform the operation of inputting the subimage, the prompt text, and the random noise image into the trained diffusion model, and continues to perform the operation, until a difference between the predicted noise subimage corresponding to each prompt text of each subimage and the random noise image is obtained. The difference is a difference between noises of the predicted noise subimage and the random noise image.

In some embodiments, the inputting the subimage, the obtained prompt text, and the random noise image into the trained diffusion model, and generating a noisy subimage according to the subimage and the random noise image by using the diffusion model includes:

performing image encoding on the subimage by using an image encoder of the diffusion model, to obtain an image encoding representation of the subimage; and superimposing the noise information corresponding to the random noise image onto image encoding information by using the diffuser of the diffusion model, to obtain the noisy subimage.

The image encoder is the image encoder in the CLIP model, and is configured to encode a subimage, so that the subimage can be represented in the latent space, and an obtained image encoding representation is an image embedding vector. The latent space is a common term in the field of generation, represents high-dimensional information of an image, and is usually configured for feature alignment of a generation result.

The noise information corresponding to the random noise image is superimposed onto the image encoding information to destroy the original image, to obtain the noisy subimage. A predicted subimage is generated again in a denoising process of the noisy subimage.

Specifically, the server performs image encoding on a subimage by using the image encoder in the CLIP model, to obtain the image encoding representation of the subimage, where the image encoding representation of the subimage is an image representation of the subimage in the latent space; and the server superimposes the noise information corresponding to the random noise image onto the image encoding information by using a diffuser of the diffusion model, to obtain the noisy subimage.

In this embodiment, image encoding is performed on the subimage by using the image encoder in the CLIP model, so that the subimage can be represented in the latent space, and superimposition of the noise information corresponding to the random noise image onto the image encoding information is also performed in the latent space. Through diffusion in the latent space, high generation quality can be maintained and computing resource consumption can be reduced.

In some embodiments, the generating a predicted noise subimage according to the noisy subimage and the prompt text includes:

performing semantic encoding on the prompt text by using a text encoder of the diffusion model, to obtain a textual semantic representation corresponding to the prompt text; and inputting the noisy subimage and the textual semantic representation into a noise predictor of the diffusion model, and outputting a predicted noise subimage by using the noise predictor.

The text encoder of the diffusion model is a text encoder of the CLIP model. Semantic encoding is performed on the prompt text by using the text encoder, so that the prompt text can be represented in the latent space. The textual semantic representation is usually a text embedding vector.

Specifically, the server performs semantic encoding on the prompt text by using the text encoder of the CLIP model in the diffuser, to obtain the textual semantic representation corresponding to the prompt text; and inputs the noisy subimage, the textual semantic representation, and encoding information of a random noise amount into the noise predictor of the diffusion model, and outputs the predicted noise subimage by using the noise predictor, where the encoding information of the random noise amount is a vector representation obtained by encoding the random noise amount.

2. Select, according to the differences calculated for the predicted noise subimages, the predicted noise subimage having the smallest difference, and obtain the prompt text based on which the selected predicted noise subimage is generated.

After obtaining a difference between a predicted noise subimage corresponding to each prompt text corresponding to each subimage and the random noise image, the server determines a prompt text based on which the predicted noise subimage is generated.

For example, as shown in FIG. 4, there are nine subimages and nine prompt texts. For a subimage 1, nine predicted noise subimages are generated based on the subimage 1 and the nine prompt texts, and a prompt text based on which a predicted noise subimage having the smallest difference from the random noise image in the nine predicted noise subimages is generated is a prompt text 3. An image label corresponding to the prompt text 3 is determined as an image label of the subimage 1. For a subimage 2, nine predicted noise subimages are generated based on the subimage 2 and the nine prompt texts, and a prompt text based on which a predicted noise subimage having the smallest difference from the random noise image in the nine predicted noise subimages is generated is a prompt text 7. An image label corresponding to the prompt text 7 is determined as an image label of the subimage 2. The remaining subimages are processed in a same processing manner, a prompt text based on which a predicted noise subimage having the smallest difference in each subimage is generated is determined, and an image label corresponding to the prompt text on which each subimage is based is determined as an image label of each subimage.

3. Determine an image label corresponding to the obtained prompt text as an image label of the subimage.

Specifically, for each subimage, after determining the prompt text based on which the predicted noise subimage having the smallest difference is generated in each subimage, the server determines an image label corresponding to the determined prompt text as an image label of each subimage.

Finally, the server may obtain the image label of the original image according to the respective image labels of the plurality of subimages.

In some embodiments, the image labels of the plurality of subimages may be all used as image labels of the original image.

In some embodiments, voting may be performed according to the image labels of the plurality of subimages, and one image label is selected from the image labels of the plurality of subimages as the image label of the original image.

For example, if the original image is divided into nine subimages, where image labels corresponding to three subimages are an image label L1, image labels corresponding to four subimages are an image label L2, and image labels corresponding to two subimages are an image label L3, the image labels L1, L2, and L3 may all be used as image labels of the original image; or voting may be performed according to an image label corresponding to each subimage, and it is determined, according to a voting result, that the image label of the original image is L2.

In this embodiment, the original image is divided into a plurality of subimages; for each subimage, based on a plurality of prompt texts and a diffusion model, predicted noise subimages corresponding to the plurality of prompt texts are generated; and a prompt text based on which a predicted noise subimage having the smallest difference is generated is determined; the image label corresponding to the determined prompt text is used as an image label of the subimage; and the respective image labels of the plurality of subimages are used as the image labels of the original image. An image label may be allocated to an image feature in each area of the original image, and the image label of the original image is added, so that there are more types of image labels of the original image, and precision of annotation of the original image higher.

In an embodiment, this embodiment provides detailed operations of an image classification method. The following operations are specifically included.

1. Obtain a prompt text template and a plurality of image labels.

2. Fill the prompt text template with each of the plurality of image labels respectively, to obtain a plurality of prompt texts corresponding to the corresponding image labels.

3. For each prompt text, input an original image, the prompt text, and a random noise image into a trained diffusion model, and perform image encoding on the original image by using an image encoder of a diffusion model, to obtain an image encoding representation of the original image.

4. Superimpose noise information corresponding to the random noise image onto image encoding information by using a diffuser of the diffusion model, to obtain a noisy image.

5. Perform semantic encoding on the prompt text by using a text encoder of the diffusion model, to obtain a textual semantic representation corresponding to the prompt text.

6. Input the noisy image and encoding information of a random noise amount corresponding to the random noise image into a first residual network of a noise predictor and output predicted noise information by using the first residual network; and input the predicted noise information and the textual semantic representation into a first attention layer of the noise predictor, and output attention information by using the first attention layer.

7. Starting from the second residual network of the noise predictor, sequentially use a next residual network as a current residual network, use a next attention layer of the noise predictor as a current attention layer, input a previous piece of attention information outputted by a previous attention layer connected to the current residual network and the encoding information of the random noise amount into the current residual network, and output predicted noise information by using the current residual network; and input the predicted noise information outputted by the current residual network and the textual semantic representation into the current attention layer, and output attention information by using the current attention layer.

8. Determine attention information outputted by the last attention layer of the noise predictor as the predicted noise image.

9. Calculate a difference between the generated predicted noise image and the random noise image.

10. Select, according to the differences calculated for the predicted noise images, the predicted noise image having the smallest difference, and acquire the prompt text based on which the selected predicted noise image is generated.

11. Use the image label corresponding to the acquired prompt text as an image label of the original image.

In this embodiment, a plurality of prompt texts are obtained, where each prompt text is generated according to a different image label. For each prompt text, an original image, a prompt text, and a random noise image are inputted into a trained diffusion model. A predicted noise image is generated by using the diffusion model. A difference between the generated predicted noise image and the random noise image is calculated. That is, each prompt text corresponds to a random noise image. The image label corresponding to a prompt text based on which a predicted noise image having the smallest corresponding difference is generated is determined as an image label of the original image. According to the foregoing method, a capability of a diffusion model can be directly migrated to multi-label classification work. While an annotation amount is reduced, the diffusion model does not need to be trained again, and an existing diffusion model is directly used to obtain a final label of an original image, thereby greatly reducing a workload.

In an embodiment, this embodiment provides a diffusion model processing method, which may be applied to an application environment shown in FIG. 1. The server 104 obtains a plurality of sample images from the terminal 102 or a data storage system. Each sample image corresponds to an image label. For each sample image, the server 104 generates a corresponding sample prompt text according to an image label of the sample image. The server 104 generates a noisy image according to the sample image and a sample random noise image by using the initial diffusion model, generates a predicted noise image according to the noisy image and the sample prompt text, and performs denoising processing on the noisy image according to the predicted noise image, to obtain a predicted image. The server 104 constructs a sample loss according to a difference between the predicted image and the sample image. The server 104 updates the initial diffusion model according to the sample loss. A trained diffusion model that is obtained after updating is configured for image classification.

In an embodiment, a diffusion model processing method is provided. A description is made by using an example in which the method is applied to the server in FIG. 1. The method specifically includes the following operations.

1. Obtain a plurality of sample images, each sample image corresponding to an image label.

Currently, there is a large field difference between training data used for a diffusion model and service data of an application scenario. Consequently, precision of image label classification of the diffusion model is low. Therefore, to resolve the foregoing problem, in this embodiment, a diffusion model suitable for the application scenario needs to be obtained before image classification is performed. To obtain the diffusion model applicable to this service, the sample images in this embodiment include a service image required in the application scenario and a general image used for the diffusion model. The diffusion model is trained by using the service image and the general image together, so that a capability of the diffusion model can be migrated to multi-label classification work of this service, thereby improving a capability of the diffusion model to classify the service image in the application scenario. In addition, the diffusion model is trained by using the service image and the general image together without requiring a large quantity of manually annotated service images in the application scenario, and only a small quantity of service images in the application scenario are required. In this way, a cost of manual annotation can be greatly reduced, the diffusion model can also be trained as soon as possible, and a function of performing image classification on the service image of the service scenario can become online in time. The general image is a sample image in a general training sample set of a diffusion model. The general image relates to sample images in various fields. For example, the general image includes a sample image in the food field, a sample image in the animal field, and a sample image in the scenery field. The service image is an image related to a specific application scenario of the present disclosure, for example, a commodity image classification scenario or a video cover image classification scenario.

Specifically, the server extracts a plurality of general images from an original training sample set used for the diffusion model, extracts a plurality of service images from the service data required in the application scenario, and determines the general image and the service image as sample images required for training the diffusion model applicable to this service.

2. For each sample image, generate a corresponding sample prompt text according to the image label of the sample image, generate a noisy image according to the sample image and a sample random noise image by using an initial diffusion model, generate a predicted noise image according to the noisy image and the sample prompt text, and perform denoising processing on the noisy image according to the predicted noise image, to obtain a predicted image.

In some embodiments, the generating a corresponding sample prompt text according to the image label of the sample image includes:

obtaining a sample prompt text template and a plurality of image labels of the sample image; and filling the sample prompt text template with each of the plurality of image labels respectively, to obtain a plurality of sample prompt texts corresponding to the corresponding image labels.

The sample prompt text template may be a general prompt template. In this embodiment, a first image label set and a second image label set are included. A first image label in the first image label set and a second image label in the second image label set are combined, to obtain a plurality of image labels. Each obtained image label includes at least one first image label or at least one second image label. The first image label in the first image label set and the second image label in the second image label set are from different image application scenarios. For example, the first image label is from an image label of a training sample in original training data of the diffusion model, and the second image label is from an image label of a service image of a service. The service refers to a specific application scenario in different fields.

A general format of a sample prompt text is a photo of {class}, and prompt texts corresponding to M image labels are respectively represented as: A photo of class1, A photo of class2, . . . , and A photo of classM.

Specifically, the server reads a plurality of first image labels from a prestored first image label set, reads a plurality of second image labels from a prestored second image label set, and fills the sample prompt text template with the plurality of first image labels and the plurality of second image labels respectively, to obtain a plurality of sample prompt texts corresponding to the corresponding image labels.

In some embodiments, the generating a noisy image according to the sample image and a sample random noise image by using an initial diffusion model includes:

performing image encoding on the sample image by using an image encoder of the initial diffusion model, to obtain an image encoding representation of the sample image; and superimposing noise information corresponding to the sample random noise image onto image encoding information by using a diffuser of the diffusion model, to obtain the noisy image.

The image encoder is an image encoder in a CLIP model, and is configured to encode a sample image, so that the sample image can be represented in a latent space, and an obtained image encoding representation is an image embedding vector. The latent space is a common term in the field of generation, represents high-dimensional information of an image, and is usually configured for feature alignment of a generation result.

The noise information corresponding to the sample random noise image is superimposed onto the image encoding information to destroy the sample image, to obtain the noisy image, and a predicted image is generated again in a denoising process of the noisy image. The image encoder is an image encoder in the CLIP model. During training of the initial diffusion model, the image encoder of the CLIP model freezes. In other words, during the training of the diffusion model, the image encoder of the CLIP model is already trained. During updating of the parameters of the initial diffusion model, parameters of the CLIP model are not updated.

Specifically, the server performs image encoding on the sample image by using the image encoder in the CLIP model, to obtain an image encoding representation of the sample image. The image encoding representation of the sample image is an image representation of the sample image in a latent space. The server superimposes, by using a diffuser of the initial diffusion model, the noise information corresponding to the sample random noise image onto the image encoding information, to obtain the noisy image.

In some embodiments, the generating a predicted noise image according to the noisy image and the sample prompt text includes:

performing semantic encoding on the sample prompt text by using a text encoder of the initial diffusion model, to obtain a sample textual semantic representation corresponding to the sample prompt text; and inputting the noisy image and the sample textual semantic representation to a noise predictor of the initial diffusion model, and outputting a predicted noise image by using the noise predictor.

The text encoder of the initial diffusion model is a text encoder of the CLIP model. Semantic encoding is performed on the sample prompt text by using the text encoder, so that the sample prompt text can be represented in the latent space. The sample textual semantic representation is usually a text embedding vector. The text encoder is a text encoder in the CLIP model. During training of the initial diffusion model, the text encoder of the CLIP model freezes. In other words, during the training of the diffusion model, the text encoder of the CLIP model is already trained. During updating of the parameters of the initial diffusion model, parameters of the CLIP model are not updated.

Specifically, the server performs semantic encoding on the sample prompt text by using a text encoder of a CLIP model in an initial diffuser, to obtain a sample textual semantic representation corresponding to the sample prompt text; and inputs the noisy image, the sample textual semantic representation, and encoding information of a sample random noise amount into the noise predictor of the initial diffusion model, and outputs the predicted noise image by using the noise predictor. The encoding information of the sample random noise amount is a vector representation obtained by encoding the sample random noise amount.

In some embodiments, the performing denoising processing on the noisy image according to the predicted noise image, to obtain a predicted image includes:

subtracting the predicted noise image from the noisy image according to a preset formula, to obtain a predicted noisy image Z_{T-1} corresponding to a previous operation of a random noise amount t; inputting the predicted noisy image, the sample textual semantic representation, and encoding information of a random noise amount t-1 that correspond to the previous operation into the noise predictor, and generating a predicted noisy image Z_{T-2} by using the noise predictor; and deducing by analogy until the noise predictor generates a predicted noisy image Z₀, and decoding the predicted noisy image Z₀ by using an image decoder, to obtain the predicted image.

3. Construct a sample loss according to a difference between the predicted image and the sample image, update the initial diffusion model according to the sample loss, a trained diffusion model that is obtained after updating being configured for image classification.

The sample loss ensures that a pixel point distance between the predicted image and the sample image is less than a preset value. The pixel point distance between the predicted image and the sample image is calculated by using the sample loss. If the pixel point distance is less than the preset value, updating of the parameters of the initial diffusion model is stopped, to obtain the trained diffusion model. The sample loss may be calculated by using the following calculation formula:

$${l}_{g} = \frac{1}{N} {\sum }_{i = 1}^{N} {( {G}_{i} - {J}_{i} )}^{2}$$

In the formula, l_{g} is a sample loss; N is a quantity of pixel points of a sample image; Gᵢ is an i^{th} pixel point in a predicted image; and Jᵢ is an i^{th} pixel in a sample image.

Specifically, the server constructs the sample loss according to the pixel distance between the predicted image and the sample image, updates the parameters of the initial diffusion model, and repeats the operation of obtaining a plurality of sample images to continue training until the sample loss is less than a preset value, and stops training of the initial diffusion model, to obtain the trained diffusion model.

In this embodiment, a diffusion model suitable for a current application scenario is trained, to avoid a problem that the diffusion model has low precision of image label classification due to a large field difference between training data used for the currently used diffusion model and service data required in the application scenario. In this way, the precision of image label classification is improved.

In an embodiment, to migrate a capability of a diffusion model to multi-label classification work of a current service, a second sample image from a service image is added to sample images, and the diffusion model is trained by using the second sample image, so that the diffusion model has a recognition capability of the current service. Specifically, operations of training the diffusion model include the following operations.

1. Obtain a training sample, the training sample including a general image and a service image, a plurality of first sample images which are general images being provided, a plurality of second sample images which are service images being provided, and an image label set formed by image labels of the plurality of first sample images being the same as an image label set formed by image labels of the plurality of second sample images.

There is a large field difference between training data used for a currently used diffusion model and service data required in an application scenario. Consequently, precision of image label classification of the diffusion model is low. Therefore, to resolve the foregoing problem, in this embodiment, before image classification is performed, a capability of the diffusion model needs to be migrated to multi-label classification work of a current service.

In this embodiment, the training sample includes the general image and the service image, the plurality of first sample images are from the general image, and the plurality of second sample images are from the service image. The plurality of first sample images and the plurality of second sample images each correspond to a plurality of respective image labels. The image label set formed by the image label of the first sample image of the plurality of first sample images is the same as the image label set formed by the image label of the second sample image of the plurality of second sample images. For example, there are 1000 first sample images in the plurality of first sample images, and image labels of the first sample images form ten image label sets, which are respectively L1, L2, L3, . . . , and L10; there are 100 second sample images in the plurality of second sample images, and image labels of the second sample images also form ten image label sets, which are also L1, L2, L3, . . . , and L10. The diffusion model is trained by using the service image and the general image together, so that the capability of the diffusion model can be migrated to multi-label classification work of the current service.

Specifically, the server may first select some images from the service image as the second sample images, select, according to the image labels of the second sample images, some images having any one or more image labels of the foregoing image labels from the general images as the first sample images, and obtain the training sample according to the first sample images and the second sample images.

The field to which the first sample image determined by using the foregoing method belongs is closer to the field to which the second sample image belongs. Determining the first sample image by using the foregoing method is to reduce a field difference between training data used for a currently used diffusion model and service data required by an application scenario. The second sample image from the service image is added to the sample images, and the diffusion model is trained by using the second sample image, so that the diffusion model can be migrated to multi-label classification work of the current service, so that the diffusion model has the recognition capability of the current service.

2. Perform first-stage model training on an initial diffusion model by using the plurality of first sample images and the plurality of second sample images in a first training stage, to obtain a trained first-stage diffusion model.

In the first training stage, the initial diffusion model is trained by using the first sample image from the general image and the second sample image from the service image, and the obtained trained first-stage diffusion model has a capability of recognizing a service image of a current service.

FIG. 8 is a schematic diagram of a training process of a first training stage of an initial diffusion image. Referring to FIG. 8, image encoding is performed on the first sample image and the second sample image by using an image encoder of an initial diffusion model, to obtain an image encoding representation of the first sample image as eₒₚₜ shown in FIG. 8, and obtain an image encoding representation of the second sample image as eₜₚₜ shown in FIG. 8. In the first training stage of the initial diffusion model, it is ensured through a construction loss that eₜₚₜ is close to eₒₚₜ as possible. Therefore, the trained first-stage diffusion model has a capability of recognizing the service image of the current service.

Specifically, for each first sample image, the server generates a corresponding sample prompt text according to the image label of the first sample image, the server inputs the first sample image, the sample prompt text, and a sample random noise image into the initial diffusion model, and the server generates a noisy image according to the first sample image and the sample random noise image by using the initial diffusion model, generates a first predicted noise image according to the noisy image and the sample prompt text, and performs denoising processing on the noisy image according to the first predicted noise image, to obtain the first predicted image; the server constructs a sample loss according to a difference between the first predicted image and the first sample image, and the server updates the initial diffusion model according to the sample loss; for each second sample image, the server generates a corresponding sample prompt text according to the image label of the second sample image and inputs the second sample image, the sample prompt text, and the sample random noise image into the updated initial diffusion model, the server generates a noisy image according to the second sample image and the sample random noise image by using the updated initial diffusion model, generates a second predicted noise image according to the noisy image and the sample prompt text, and the server performs denoising processing on the noisy image according to the second predicted noise image, to obtain a second predicted image; and the server constructs a sample loss according to a difference between the second predicted image and the second sample image, and the server continues to update the initial diffusion model according to the sample loss until a training stop condition is satisfied, to obtain the trained first-stage diffusion model. The training stop condition may be that a sample damage is less than a preset value, or that a number of iterations reaches a preset number of times. A method for training each second sample image is the method for training a sample image in the foregoing embodiment. Therefore, a specific training process of the second sample image is not described herein again.

3. Perform second-stage model training on the trained first-stage diffusion model by using the plurality of first sample images in a second training stage, to obtain a trained second-stage diffusion model.

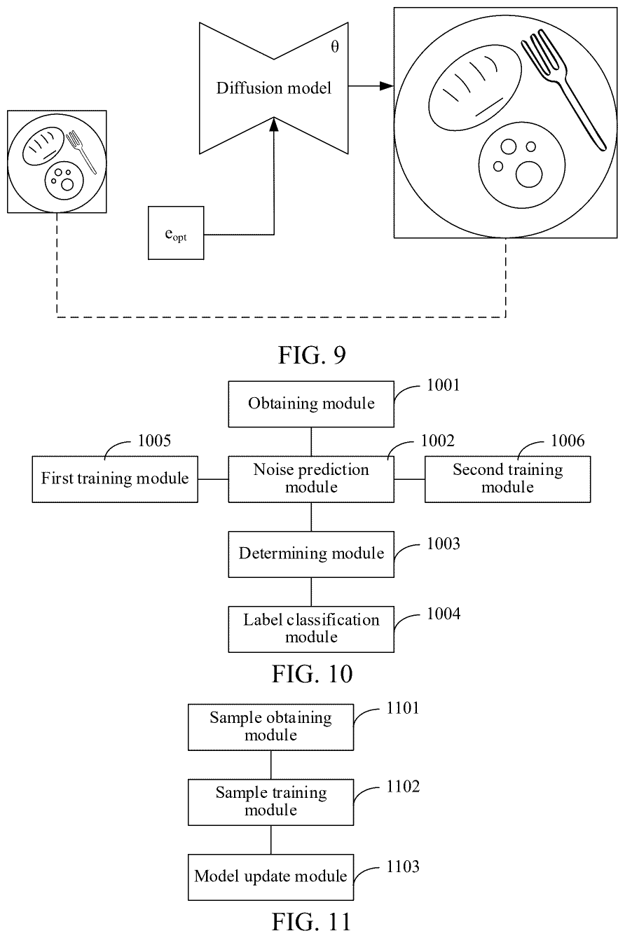

FIG. 9 is a schematic diagram of a training process of a second training stage of an initial diffusion image. Referring to FIG. 9, for example, in the second training stage, the second sample images from the service images are deleted, and only the first sample images from the general images are used to train the trained first-stage diffusion model, to avoid overfitting caused by introducing excessive service images, thereby ensuring generalization of the diffusion model. The generalization refers to a capability of a model after training being applied to new data and making accurate prediction. In the second training stage, the reconstruction loss is to use eₒₚₜ to directly achieve a capability of an original diffusion model, to avoid that the image labels of the service images need to be inputted again for alignment each time.

Specifically, for each general image, the server generates a corresponding sample prompt text according to an image label of the general image, the server inputs the general image, the sample prompt text, and the sample random noise image into the initial diffusion model, the server generates a noisy image according to the general image and the sample random noise image by using the initial diffusion model and generates a first predicted noise image according to the noisy image and the sample prompt text, and the server performs denoising processing on the noisy image according to the first predicted noise image, to obtain a first predicted image; and the server constructs a sample loss according to a difference between the first predicted image and the general image and updates the trained second-stage diffusion model according to the sample loss.

4. Determine the trained second-stage diffusion model as the trained diffusion model.

In this embodiment, the initial diffusion model is trained by using the first sample image from the general image and the second sample image from the service image, and the obtained trained first-stage diffusion model has a capability of recognizing a service image of a current service; and in the second training stage, the second sample images from the service images are deleted, and only the first sample images from the general images are used to train the trained first-stage diffusion model, to avoid overfitting caused by introducing excessive service images, thereby ensuring generalization of the diffusion model. The diffusion model obtained through training by using the foregoing method can avoid a problem that a current diffusion model has low precision of image label classification due to a large field difference between training data used for the diffusion model and service data required in an application scenario. In this way, the precision of image label classification is improved.

In an embodiment, detailed operations of a diffusion model processing method are provided. The following operations are specifically included.

1. Obtain a training sample, the training sample including a general image and a service image, a plurality of first sample images which are general images being provided, a plurality of second sample images which are service images being provided, and an image label set formed by image labels of the plurality of first sample images being the same as an image label set formed by image labels of the plurality of second sample images.

2. For each first sample image, generate a corresponding sample prompt text according to the image label of the first sample image, input the first sample image, the sample prompt text, and a sample random noise image into an initial diffusion model, and generate a noisy image according to the first sample image and the sample random noise image by using the initial diffusion model, generate a first predicted noise image according to the noisy image and the sample prompt text, and perform denoising processing on the noisy image according to the first predicted noise image, to obtain a first predicted image; and construct a sample loss according to a difference between the first predicted image and the first sample image, and update the initial diffusion model according to the sample loss.

3. For each second sample image, generate a corresponding sample prompt text according to the image label of the second sample image and input the second sample image, the sample prompt text, and the sample random noise image into the updated initial diffusion model, generate a noisy image according to the second sample image and the sample random noise image by using the updated initial diffusion model, generate a second predicted noise image according to the noisy image and the sample prompt text, and perform denoising processing on the noisy image according to the second predicted noise image, to obtain a second predicted image; and construct a sample loss according to a difference between the second predicted image and the second sample image, and continue to update the initial diffusion model according to the sample loss until a training stop condition is satisfied, to obtain the trained first-stage diffusion model.

4. In a second training stage, delete the second sample image that is from the service image, train the initial diffusion model by using only the first sample image from the general image, for each first sample image, generate a corresponding sample prompt text according to the image label of the first sample image, input the first sample image, the sample prompt text, and the sample random noise image into the initial diffusion model, generate a noisy image according to the first sample image and the sample random noise image by using the initial diffusion model, generate a first predicted noise image according to the noisy image and the sample prompt text, and perform denoising processing on the noisy image according to the first predicted noise image, to obtain a first predicted image; and construct a sample loss according to a difference between the first predicted image and the first sample image, update, according to the sample loss, the trained first-stage diffusion model, and determine the trained second-stage diffusion model as a trained diffusion model, the trained diffusion model being configured for image classification.

In this embodiment, the initial diffusion model is trained by using the first sample image from the general image and the second sample image from the service image, and the obtained trained first-stage diffusion model has a capability of recognizing a service image of a current service; and in the second training stage, the second sample images from the service images are deleted, and only the first sample images from the general images are used to train the trained first-stage diffusion model, to avoid overfitting caused by introducing excessive service images, thereby ensuring generalization of the diffusion model.

Although the various steps in the flowcharts involved in the embodiments as described above are shown in sequence as indicated by the arrows, these steps are not necessarily performed in the order indicated by the arrows. Unless otherwise explicitly specified in this specification, execution of the steps is not strictly limited, and the steps may be performed in other sequences. Moreover, at least some of the steps in the flowcharts involved in the embodiments as described above may include a plurality of steps or a plurality of stages. These steps or stages are not necessarily performed at the same time, but may be performed at different times. These steps or stages are not necessarily performed in sequence, but may be performed in turn or in alternation with other steps or at least some of the steps or stages in other steps.

Based on the same invention concept, an embodiment of the present disclosure further provides an image classification apparatus for implementing the foregoing image classification method. The implementation solution for resolving the problems that is provided by the apparatus is similar to the implementation solution described in the foregoing method. Therefore, for the specific limitations in one or more embodiments of the image classification apparatus provided below, refer to the foregoing limitations for the image classification method, and the descriptions are not described herein again.

In an embodiment, as shown in FIG. 10, an image classification apparatus is provided, which includes: an obtaining module 1001, a noise prediction module 1002, a determining module 1003, and a label classification module 1004.

The obtaining module 1001 is configured to obtain an original image and a plurality of prompt texts, each prompt text being generated according to an image label, and each image label being a preset image category.

The noise prediction module 1002 is configured to: for each prompt text, input the original image, the prompt text, and a random noise image into a trained diffusion model to generate a noisy image according to the original image and the random noise image, generate a predicted noise image according to the noisy image and the prompt text, and calculate a difference between the generated predicted noise image and the random noise image.

The determining module 1003 is configured to select, according to the differences calculated for the predicted noise images, the predicted noise image having a smallest difference, and acquire the prompt text based on which the selected predicted noise image is generated.

The label classification module 1004 is configured to use the image label corresponding to the acquired prompt text as an image label of the original image.

In an embodiment, the noise prediction module 1002 is further configured to perform image encoding on the original image by using an image encoder of the diffusion model, to obtain an image encoding representation of the original image; and superimpose noise information corresponding to the random noise image onto image encoding information by using a diffuser of the diffusion model, to obtain the noisy image.

In an embodiment, the noise prediction module 1002 is further configured to perform semantic encoding on the prompt text by using a text encoder of the diffusion model, to obtain a textual semantic representation corresponding to the prompt text; and input the noisy image and the textual semantic representation into a noise predictor of the diffusion model, and output a predicted noise image by using the noise predictor.

In an embodiment, the noise predictor includes a plurality of residual networks and attention layers that are alternately connected; and the noise prediction module 1002 is further configured to input the noisy image and encoding information of a random noise amount corresponding to the random noise image into a first residual network, and output predicted noise information by using the first residual network; input the predicted noise information and the textual semantic representation into a first attention layer, and output attention information by using the first attention layer; starting from a second residual network, sequentially use a next residual network as a current residual network, use a next attention layer as a current attention layer, input a previous piece of attention information outputted by a previous attention layer connected to the current residual network and the encoding information of the random noise amount into the current residual network, and output predicted noise information by using the current residual network; input the predicted noise information outputted by the current residual network and the textual semantic representation into the current attention layer, and output attention information by using the current attention layer; and determine attention information outputted by a last attention layer as the predicted noise image.

In an embodiment, the obtaining module 1001 is further configured to obtain a prompt text template and a plurality of image labels; and fill the prompt text template with each of the plurality of image labels respectively, to obtain a plurality of prompt texts corresponding to the corresponding image labels.

In an embodiment, the obtaining module 1001 is further configured to divide the original image, to obtain a plurality of subimages; the noise prediction module 1002 is further configured to: for each subimage, sequentially obtain a prompt text from the plurality of prompt texts, for each obtained prompt text, input the subimage, the obtained prompt text, and the random noise image into the trained diffusion model, generate a noisy subimage according to the subimage and the random noise image by using the diffusion model, generate a predicted noise subimage according to the noisy subimage and the prompt text, and calculate a difference between the generated predicted noise subimage and the random noise image; the determining module 1003 is further configured to select, according to the difference calculated for each predicted noise subimage, a predicted noise subimage having a smallest corresponding difference, and obtain a prompt text based on which the selected predicted noise subimage is generated; and the label classification module 1004 is further configured to determine the image label corresponding to the obtained prompt text as an image label of the subimage; and obtain the image label of the original image according to respective image labels of the plurality of subimages.

In an embodiment, the apparatus further includes: a first training module 1005.

The first training module 1005 is configured to obtain a training sample, the training sample including a sample text, a sample image, and annotation information indicating whether the sample text matches the sample image; perform image encoding on the sample image by using an initial image encoder, to obtain an image encoding representation of the sample image; perform semantic encoding on the sample text by using an initial text encoder, to obtain a textual semantic representation corresponding to the sample text; calculate a similarity between the image encoding representation and the textual semantic representation, and determine, according to the similarity, a prediction result indicating whether the sample text matches the sample image; and construct a sample loss according to a difference between the annotation information and the prediction result, and after updating the initial image encoder and the initial text encoder according to the sample loss, repeat the operation of obtaining a training sample to continue training, to obtain the image encoder of the diffusion model and the text encoder of the diffusion model.

In an embodiment, the apparatus further includes: a second training module 1006.

The second training module 1006 is configured to obtain a training sample, the training sample including a general image and a service image, a plurality of first sample images which are general images being provided, a plurality of second sample images which are service images being provided, and an image label set formed by image labels of the plurality of first sample images being the same as an image label set formed by image labels of the plurality of second sample images; perform first-stage model training on an initial diffusion model by using the plurality of first sample images and the plurality of second sample images in a first training stage, to obtain a trained first-stage diffusion model; perform second-stage model training on the trained first-stage diffusion model by using the plurality of first sample images in a second training stage, to obtain a trained second-stage diffusion model; and determine the trained second-stage diffusion model as the trained diffusion model.

In an embodiment, the second training module 1006 is configured to: for each sample image, generate a corresponding sample prompt text according to an image label of the sample image, generate a noisy image according to the sample image and a sample random noise image by using the initial diffusion model, generate a predicted noise image according to the noisy image and the sample prompt text, and perform denoising processing on the noisy image according to the predicted noise image, to obtain a predicted image; and construct a sample loss according to a difference between the predicted image and the sample image, and update the initial diffusion model according to the sample loss.

All or a part of the modules in the foregoing image classification apparatus may be implemented by using software, hardware, or a combination thereof. The modules may be built in or stand alone from processor(s) in a computer device in a form of hardware, or may be stored in a memory in a computer device in a form of software, so that processor(s) can invoke and execute operations corresponding to the modules.

Based on the same inventive concept, an embodiment of the present disclosure further provides a diffusion model processing apparatus for implementing the foregoing diffusion model processing method. An implementation solution for resolving problems that is provided by the apparatus is similar to the implementation solution described in the foregoing method. Therefore, for specific limitations of the following one or more embodiments of the diffusion model apparatus, reference may be made to the foregoing limitations to the diffusion model processing method. Details are not described herein again.

In an embodiment, as shown in FIG. 11, a diffusion model processing apparatus is provided, which includes: a sample obtaining module 1101, a sample training module 1102, and a model update module 1103.

The sample obtaining module 1101 is configured to obtain a plurality of sample images, each sample image corresponding to an image label;

the sample training module 1102 is configured to: for each sample image, generate a corresponding sample prompt text according to an image label of the sample image, generate a noisy image according to the sample image and a sample random noise image by using the initial diffusion model, generate a predicted noise image according to the noisy image and the sample prompt text, and perform denoising processing on the noisy image according to the predicted noise image, to obtain a predicted image; and

the model update module 1103 is configured to construct a sample loss according to a difference between the predicted image and the sample image, and update the initial diffusion model according to the sample loss, a trained diffusion model that is obtained after updating being configured for image classification.

In an embodiment, the sample image includes a plurality of first sample images and a plurality of second sample images, the first sample image is from a general image, the second sample image is from a service image, and an image label set formed by an image label of the first sample image of the plurality of first sample images is the same as an image label set formed by an image label of the second sample image of the plurality of second sample images; the sample training module 1102 is further configured to perform first-stage model training on an initial diffusion model by using the plurality of first sample images and the plurality of second sample images in a first training stage, to obtain a trained first-stage diffusion model; and perform second-stage model training on the trained first-stage diffusion model by using the plurality of first sample images in a second training stage, to obtain a trained second-stage diffusion model; and

the model update module 1103 is further configured to determine the trained second-stage diffusion model as the trained diffusion model.

In an embodiment, the sample training module 1102 is further configured to: for each first sample image, generate a corresponding sample prompt text according to the image label of the first sample image, input the first sample image, the sample prompt text, and a sample random noise image into an initial diffusion model, and generate a noisy image according to the first sample image and the sample random noise image by using the initial diffusion model, generate a first predicted noise image according to the noisy image and the sample prompt text, and perform denoising processing on the noisy image according to the first predicted noise image, to obtain a first predicted image; construct a sample loss according to a difference between the first predicted image and the first sample image, and update the initial diffusion model according to the sample loss; for each second sample image, generate a corresponding sample prompt text according to the image label of the second sample image and input the second sample image, the sample prompt text, and the sample random noise image into the updated initial diffusion model, generate a noisy image according to the second sample image and the sample random noise image by using the updated initial diffusion model, generate a second predicted noise image according to the noisy image and the sample prompt text, and perform denoising processing on the noisy image according to the second predicted noise image, to obtain a second predicted image; and construct a sample loss according to a difference between the second predicted image and the second sample image, and continue to update the initial diffusion model according to the sample loss until a training stop condition is satisfied, to obtain the trained first-stage diffusion model.

All of a part of the modules in the diffusion model processing apparatus may be implemented by software, hardware, and a combination thereof. The modules may be built in or stand alone from a processor in a computer device in a form of hardware, or may be stored in a memory in a computer device in a form of software, so that a processor can invoke and execute operations corresponding to the modules.

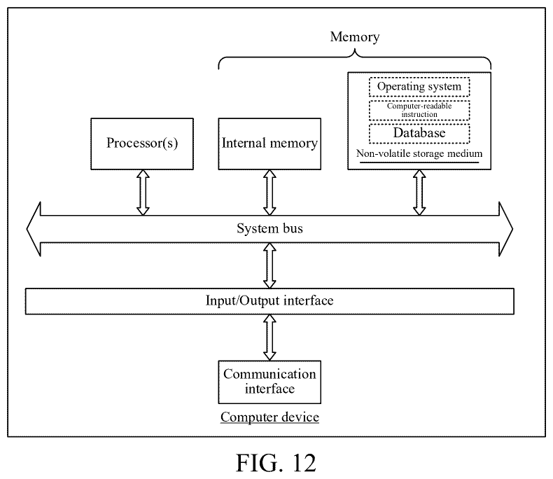

In an embodiment, a computer device is provided. The computer device may be a server, and an internal structure diagram thereof may be shown in FIG. 12. The computer device includes a processor, a memory, an input/output (I/O for short) interface, and a communication interface. The processor, the memory, and the input/output interface are connected to each other by using a system bus, and the communication interface is connected to the system bus by using the input/output interface. The processor of the computer device is configured to provide computing and control capability. The memory of the computer device includes a non-volatile storage medium and an internal memory. The non-volatile storage medium has an operating system, computer readable instructions, and a database stored therein. The internal memory provides a running environment for the operating system and the computer-readable instructions in the non-volatile storage medium. The database of the computer device is configured to store a prompt text. The input/output interface of the computer device is configured to exchange information between the processor and an external device. The communication interface of the computer device is configured to connect and communicate with an external terminal through a network. The computer-readable instructions are executed by the processor to implement an image classification method.

A person skilled in the art may understand that, the structure shown in FIG. 12 is merely a block diagram of a partial structure related to the solution in the present disclosure, and does not constitute a limitation on the computer device to which the solution in the present disclosure is applied. Specifically, the computer device may include more or fewer components than those shown in the figure, or some merged components, or different component arrangements.

In an embodiment, a computer device is provided, including a memory and a processor. The memory has computer-readable instructions stored therein, and the processor, when executing the computer-readable instructions, implements the operations in the foregoing method embodiments.

In an embodiment, a computer-readable storage medium is provided, having computer-readable instructions stored therein. The computer-readable instructions, when executed by a processor, implement the operations in the foregoing method embodiments.

In an embodiment, a computer program product is provided, including computer-readable instructions. The computer-readable instructions, when executed by a processor, implement the operations in the foregoing method embodiments.

User information (including, but not limited to, user equipment information, user personal information, and the like) and data (including, but not limited to, data for analysis, stored data, displayed data, and the like) involved in the present disclosure are all information and data authorized by users or fully authorized by all parties, and collection, use, and processing of relevant data need to comply with relevant laws, regulations, and standards of relevant countries and regions.

A person of ordinary skill in the art may understand that all or some of the procedures of the method according to the foregoing embodiments may be implemented by computer-readable instructions instructing relevant hardware. The computer-readable instructions may be stored in a non-volatile computer-readable storage medium. When the computer-readable instructions are executed, the procedures of the method according to the foregoing embodiments may be included. References to the memory, the database, or another medium used in the embodiments provided in the present disclosure may all include at least one of a non-volatile or a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random access memory (FRAM), a phase change memory (PCM), a graphene memory, and the like. The volatile memory may include a random access memory (RAM) and an external cache. For the purpose of illustration but not limitation, the RAM is available in many forms, for example, a static random access memory (SRAM) or a dynamic random access memory (DRAM). The databases involved in the embodiments provided in the present disclosure may include at least one of a relational database and a non-relational database. The non-relational database may include, but is not limited to, a blockchain-based distributed database and the like. The processors involved in the embodiments provided in the present disclosure can be general-purpose processors, central processing units, graphics processors, digital signal processors, programmable logic devices, data processing logic devices based on quantum computing, and are not limited thereto.

The technical features of the foregoing embodiments may be combined in different manners. In order to make the descriptions concise, not all the possible combinations of the technical features in the foregoing embodiments are described. However, provided that there is no contradiction between the combinations of these technical features, the combinations are to be considered within the scope of this specification.

The foregoing embodiments show only several example implementations of the present disclosure, and are described in detail, but are not to be construed as a limitation on the patent scope of the present disclosure. A person of ordinary skill in the art may make several transformations and improvements without departing from the concept of the present disclosure. These transformations and improvements all belong to and are encompassed within the protection scope of the present disclosure. Therefore, the scope of protection of the present disclosure is subject to the appended claims.

What is claimed is:

1. An image classification method, performed by a computer device, the method comprising:
obtaining an original image and a plurality of prompt texts, each prompt text being generated according to an image label, and each image label corresponding to a preset image category;
for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image;
selecting, according to differences calculated for predicted noise images, a predicted noise image having a smallest difference, and acquiring a prompt text based on which the selected predicted noise image is generated; and
using an image label corresponding to the acquired prompt text as an image label of the original image.

2. The method according to claim 1, wherein inputting the original image, the prompt text, and the random noise image into the trained diffusion model comprises:
performing image encoding on the original image by using an image encoder of the diffusion model, to obtain an image encoding representation of the original image; and
superimposing noise information corresponding to the random noise image onto image encoding information by using a diffuser of the diffusion model, to obtain the noisy image.

3. The method according to claim 2, wherein generating the predicted noise image according to the noisy image and the prompt text comprises:
performing semantic encoding on the prompt text by using a text encoder of the diffusion model, to obtain a textual semantic representation corresponding to the prompt text; and
inputting the noisy image and the textual semantic representation into a noise predictor of the diffusion model, and outputting the predicted noise image by using the noise predictor.

4. The method according to claim 3, wherein the noise predictor comprises a plurality of residual networks and attention layers that are alternately connected; and inputting the noisy image and the textual semantic representation into the noise predictor of the diffusion model, and outputting the predicted noise image by using the noise predictor comprises:
inputting the noisy image and encoding information of a random noise amount corresponding to the random noise image into a first residual network, and outputting predicted noise information through the first residual network; inputting the predicted noise information and the textual semantic representation into a first attention layer, and outputting attention information through the first attention layer;
starting from a second residual network, sequentially using a next residual network as a current residual network, using a next attention layer as a current attention layer, inputting a previous piece of attention information outputted by a previous attention layer connected to the current residual network and the encoding information of the random noise amount into the current residual network, and outputting predicted noise information by using the current residual network; inputting the predicted noise information outputted by the current residual network and the textual semantic representation into the current attention layer, and outputting attention information by using the current attention layer; and
determining attention information outputted by a last attention layer as the predicted noise image.

5. The method according to claim 3, further comprising:
obtaining a training sample, the training sample comprising a sample text, a sample image, and annotation information indicating whether the sample text matches the sample image;
performing image encoding on the sample image by using an initial image encoder, to obtain an image encoding representation of the sample image;
performing semantic encoding on the sample text by using an initial text encoder, to obtain a textual semantic representation corresponding to the sample text;
calculating a similarity between the image encoding representation and the textual semantic representation, and determining, according to the similarity, a prediction result indicating whether the sample text matches the sample image; and
constructing a sample loss according to a difference between the annotation information and the prediction result, and after updating the initial image encoder and the initial text encoder according to the sample loss, repeating the operation of obtaining a training sample to continue training, to obtain the image encoder of the diffusion model and the text encoder of the diffusion model.

6. The method according to claim 1, wherein obtaining the plurality of prompt texts comprises:
obtaining a prompt text template and a plurality of image labels; and
filling the prompt text template with each of the plurality of image labels respectively, to obtain a plurality of prompt texts corresponding to the image labels.

7. The method according to claim 1, further comprising:
dividing the original image, to obtain a plurality of subimages; and
respectively performing following operations for each subimage: sequentially obtaining a prompt text from the plurality of prompt texts; for each obtained prompt text, inputting the subimage, the obtained prompt text, and the random noise image into the trained diffusion model to generate a noisy subimage according to the subimage and the random noise image, generating a predicted noise subimage according to the noisy subimage and the prompt text, and calculating a difference between the predicted noise subimage and the random noise image; selecting, according to differences calculated for predicted noise subimages, a predicted noise subimage having a smallest difference, and acquiring a prompt text based on which the selected predicted noise subimage is generated; and using an image label corresponding to the acquiring prompt text as an image label of the subimage; and
obtaining the image label of the original image according to respective image labels of the plurality of subimages.

8. The method according to claim 1, wherein the trained diffusion model is obtained by training operations comprising:
obtaining a training sample, the training sample comprising a general image and a service image, a plurality of first sample images which are general images being provided, a plurality of second sample images which are service images being provided, and an image label set including image labels the plurality of first sample images being same as an image label set including image labels of the plurality of second sample images;
performing first-stage model training on an initial diffusion model by using the plurality of first sample images and the plurality of second sample images in a first training stage, to obtain a trained first-stage diffusion model;
performing second-stage model training on the trained first-stage diffusion model by using the plurality of first sample images in a second training stage, to obtain a trained second-stage diffusion model; and
determining the trained second-stage diffusion model as the trained diffusion model.

9. The method according to claim 8, wherein training operations in each training stage comprises:
for each sample image, generating a corresponding sample prompt text according to an image label of the sample image, generating a noisy image according to the sample image and a sample random noise image by using the initial diffusion model, generating a predicted noise image according to the noisy image and the sample prompt text, and performing denoising processing on the noisy image according to the predicted noise image, to obtain a predicted image; and
constructing a sample loss according to a difference between the predicted image and the sample image, and updating the initial diffusion model according to the sample loss.

10. A computer device, comprising:
one or more processors and a memory containing computer-readable instructions that, when being executed, cause the one or more processors to perform:
obtaining an original image and a plurality of prompt texts, each prompt text being generated according to an image label, and each image label corresponding to a preset image category;
for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image;
selecting, according to differences calculated for predicted noise images, a predicted noise image having a smallest difference, and acquiring a prompt text based on which the selected predicted noise image is generated; and
using an image label corresponding to the acquired prompt text as an image label of the original image.

11. The device according to claim 10, wherein the one or more processors are further configured to perform:
performing image encoding on the original image by using an image encoder of the diffusion model, to obtain an image encoding representation of the original image; and
superimposing noise information corresponding to the random noise image onto image encoding information by using a diffuser of the diffusion model, to obtain the noisy image.

12. The device according to claim 11, wherein the one or more processors are further configured to perform:
performing semantic encoding on the prompt text by using a text encoder of the diffusion model, to obtain a textual semantic representation corresponding to the prompt text; and
inputting the noisy image and the textual semantic representation into a noise predictor of the diffusion model, and outputting the predicted noise image by using the noise predictor.

13. The device according to claim 12, wherein the noise predictor comprises a plurality of residual networks and attention layers that are alternately connected; and the one or more processors are further configured to perform:
inputting the noisy image and encoding information of a random noise amount corresponding to the random noise image into a first residual network, and outputting predicted noise information through the first residual network; inputting the predicted noise information and the textual semantic representation into a first attention layer, and outputting attention information through the first attention layer;
starting from a second residual network, sequentially using a next residual network as a current residual network, using a next attention layer as a current attention layer, inputting a previous piece of attention information outputted by a previous attention layer connected to the current residual network and the encoding information of the random noise amount into the current residual network, and outputting predicted noise information by using the current residual network; inputting the predicted noise information outputted by the current residual network and the textual semantic representation into the current attention layer, and outputting attention information by using the current attention layer; and
determining attention information outputted by a last attention layer as the predicted noise image.

14. The device according to claim 12, wherein the one or more processors are further configured to perform:
obtaining a training sample, the training sample comprising a sample text, a sample image, and annotation information indicating whether the sample text matches the sample image;
performing image encoding on the sample image by using an initial image encoder, to obtain an image encoding representation of the sample image;
performing semantic encoding on the sample text by using an initial text encoder, to obtain a textual semantic representation corresponding to the sample text;
calculating a similarity between the image encoding representation and the textual semantic representation, and determining, according to the similarity, a prediction result indicating whether the sample text matches the sample image; and
constructing a sample loss according to a difference between the annotation information and the prediction result, and after updating the initial image encoder and the initial text encoder according to the sample loss, repeating the operation of obtaining a training sample to continue training, to obtain the image encoder of the diffusion model and the text encoder of the diffusion model.

15. The device according to claim 10, wherein the one or more processors are further configured to perform:
obtaining a prompt text template and a plurality of image labels; and
filling the prompt text template with each of the plurality of image labels respectively, to obtain a plurality of prompt texts corresponding to the image labels.

16. The device according to claim 10, wherein the one or more processors are further configured to perform:
dividing the original image, to obtain a plurality of subimages; and
respectively performing following operations for each subimage: sequentially obtaining a prompt text from the plurality of prompt texts; for each obtained prompt text, inputting the subimage, the obtained prompt text, and the random noise image into the trained diffusion model to generate a noisy subimage according to the subimage and the random noise image, generating a predicted noise subimage according to the noisy subimage and the prompt text, and calculating a difference between the predicted noise subimage and the random noise image; selecting, according to differences calculated for predicted noise subimages, a predicted noise subimage having a smallest difference, and acquiring a prompt text based on which the selected predicted noise subimage is generated; and using an image label corresponding to the acquiring prompt text as an image label of the subimage; and
obtaining the image label of the original image according to respective image labels of the plurality of subimages.

17. The device according to claim 10, wherein the one or more processors are further configured to perform training operations comprising:
obtaining a training sample, the training sample comprising a general image and a service image, a plurality of first sample images which are general images being provided, a plurality of second sample images which are service images being provided, and an image label set including image labels the plurality of first sample images being same as an image label set including image labels of the plurality of second sample images;
performing first-stage model training on an initial diffusion model by using the plurality of first sample images and the plurality of second sample images in a first training stage, to obtain a trained first-stage diffusion model;
performing second-stage model training on the trained first-stage diffusion model by using the plurality of first sample images in a second training stage, to obtain a trained second-stage diffusion model; and
determining the trained second-stage diffusion model as the trained diffusion model.

18. The device according to claim 17, wherein training operations in each training stage comprises:
for each sample image, generating a corresponding sample prompt text according to an image label of the sample image, generating a noisy image according to the sample image and a sample random noise image by using the initial diffusion model, generating a predicted noise image according to the noisy image and the sample prompt text, and performing denoising processing on the noisy image according to the predicted noise image, to obtain a predicted image; and
constructing a sample loss according to a difference between the predicted image and the sample image, and updating the initial diffusion model according to the sample loss.

19. A non-transitory computer-readable storage medium containing computer-readable instructions that, when being executed, cause at least one processor to perform:
obtaining an original image and a plurality of prompt texts, each prompt text being generated according to an image label, and each image label corresponding to a preset image category;
for each prompt text, inputting the original image, the prompt text, and a random noise image into a trained diffusion model to generate a noisy image based on the original image and the random noise image, generating a predicted noise image according to the noisy image and the prompt text, and calculating a difference between the predicted noise image and the random noise image;
selecting, according to differences calculated for predicted noise images, a predicted noise image having a smallest difference, and acquiring a prompt text based on which the selected predicted noise image is generated; and
using an image label corresponding to the acquired prompt text as an image label of the original image.

20. The storage medium according to claim 19, wherein the at least one processor is further configured to perform:
performing image encoding on the original image by using an image encoder of the diffusion model, to obtain an image encoding representation of the original image; and
superimposing noise information corresponding to the random noise image onto image encoding information by using a diffuser of the diffusion model, to obtain the noisy image.
